(19) United States
(12) Patent Application Publication
(10) Pub. No.: US 2020/0088512 A1
(43) Pub. Date: Mar. 19, 2020

(54) DEPTH INFORMATION CONSTRUCTION SYSTEM, ASSOCIATED ELECTRONIC DEVICE, AND METHOD FOR CONSTRUCTING DEPTH INFORMATION

(71) Applicant: SHENZHEN GOODIX TECHNOLOGY CO., LTD., GUANGDONG (CN)

(72) Inventor: MENG-TA YANG, TAIPEI CITY (TW)

(21) Appl. No.: 16/394,745

(22) Filed: Apr. 25, 2019

Related U.S. Application Data
(60) Provisional application No. 62/732,935, filed on Sep. 18, 2018.

(51) Int. Cl. G01B 11/22; G02B 5/02; G02B 27/42; G02B 27/30

(52) U.S. Cl. CPC G01B 11/22; G02B 27/30; G02B 27/4244; G02B 5/0205

(57) ABSTRACT

A depth information construction system is arranged to generate an output signal for a processing circuit to construct a depth information of an object according to the output signal. The depth information construction system includes a structured light generator, a diffuser lens assembly, and a sensor. The structured light generator is arranged to project a structured light onto the object to generate a reflected structured light. The diffuser lens assembly is disposed adjacent to the structured light generator, and is arranged to receive the reflected structured light and generate a filtered light. The sensor is arranged to sense the filtered light to generate the output signal.

### CROSS REFERENCE TO RELATED APPLICATIONS

This application claims the benefit of U.S. provisional application 62/732,935, filed on Sep. 18, 2018, which is incorporated by reference in its entirety.

### TECHNICAL FIELD

The present disclosure relates to a system and, more particularly, to a depth information construction system.

### BACKGROUND

Conventional devices for constructing depth information of an object usually require a large area and a high computing power to build a three dimensional (3D) image. With high computing power, however, the battery life for such devices is accordingly limited. However, due to growing demand tier a light and thin device having long battery life, a novel design for generating the depth information is required to solve the aforementioned problem.

### SUMMARY OF THE INVENTION

One of the objectives of the present disclosure is to provide a depth information construction system, associated electronic device and method.

According to an embodiment of the present disclosure, a depth information construction system is disclosed. The depth information construction system is configured to generate an output signal for a processing circuit to construct a depth information of an object according to the output signal. The depth information construction system includes a structured light generator, a diffuser lens assembly, and a sensor. The structured light generator is arranged to project a structured light onto the object to generate a reflected structured light. The diffuser lens assembly is disposed adjacent to the structured light generator, and arranged to receive the reflected structured light and generate a filtered light. The sensor is arranged to sense the filtered light to generate the output signal.

According to an embodiment of the present disclosure, an electronic device for constructing a depth information of an object is disclosed. The electronic device includes a structured light generator, a diffuser lens assembly, a sensor and a processor. The structured light generator is arranged to project a structured light onto the object to generate a reflected structured light. The diffuser lens assembly is disposed adjacent to the structured light generator, and arranged to receive the reflected structured light and generate a filtered light. The sensor is arranged to sense the filtered light to generate an output signal. The processor is arranged to construct the depth information according to the output signal.

According to an embodiment of the present disclosure, a depth information constructing method for constructing a depth information of an object is disclosed. The depth information constructing method comprises: projecting a structured light onto the object to generate a reflected structured light; receiving the reflected structured light; filtering the reflected structured light to generate a filtered light; sensing the filtered light to generate an output signal: and constructing the depth information according to the output signal.

### BRIEF DESCRIPTION OF THE DRAWINGS

Aspects of the present disclosure are best understood from the following detailed description when read with the accompanying figures. It should noted that, in accordance with the standard practice in the industry, various features are not drawn to scale. In fact, the dimensions of the various features may be arbitrarily increased or reduced for clarity of discussion.

FIG. 1 is a diagram illustrating a depth information construction system in accordance with an embodiment of the present disclosure.

FIG. 2A is a diagram illustrating a structured light generator in accordance with an embodiment of the present disclosure.

FIG. 2B is a diagram illustrating a structured light in accordance with an embodiment of the present disclosure.

FIG. 2C is a diagram illustrating a pattern on a diffractive optical element in accordance with an embodiment of the present disclosure.

FIG. 3 is a diagram illustrating an electronic device applying a depth information construction system in accordance with an embodiment of the present disclosure.

FIG. 4 is a diagram illustrating a diffuser lens assembly and a sensor in accordance with an embodiment of the present disclosure.

FIG. 5 is a diagram illustrating a depth information construction system in accordance with another embodiment of the present disclosure.

FIG. 6 is a flowchart illustrating a depth information constructing method in accordance with an embodiment of the present disclosure.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another elements) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

The depth information construction system disclosed by the present disclosure for generating the depth information of an object does not require a processor having high computing power, and consumes less area on a device. In addition, the electronic device applying the depth information construction system disclosed by the present disclosure consumes less battery power, and battery life is extended accordingly.

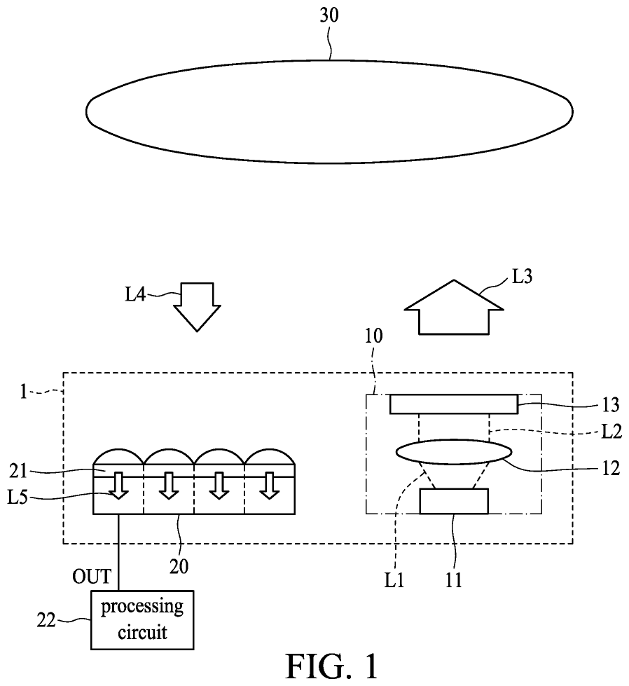

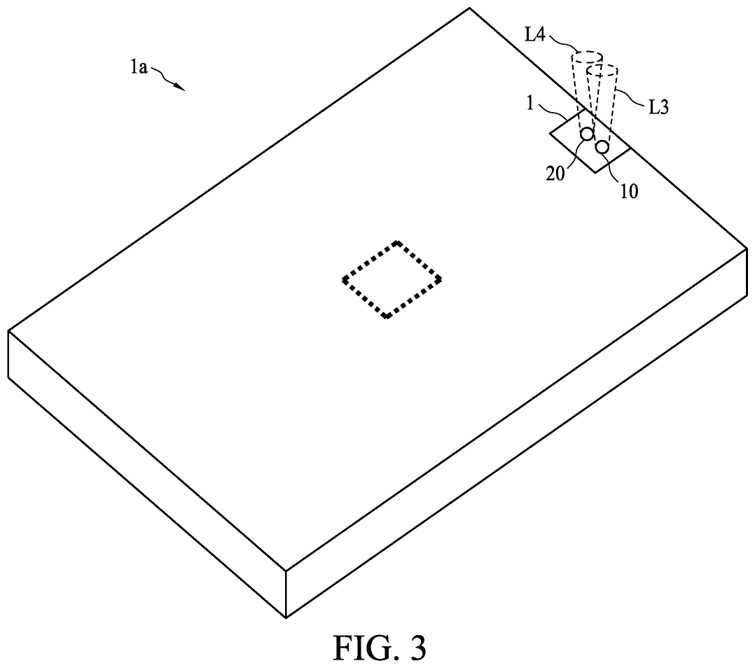

FIG. 1 is a diagram illustrating a depth information construction system 1 in accordance with an embodiment of the present disclosure. The depth information construction system 1 includes a structured light generator 10, a plurality of sensors 20, and a plurality of diffuser lens assemblies 21 corresponding to the sensors 20 respectively. The structured light generator 10 projects a structured light L3 having a pattern onto an object 30. The diffuser lens assemblies 21 are disposed adjacent to the structured light generator 10, and are arranged to receive a reflected structured light L4 reflected by the object 30 to generate a filtered light L5. The sensors 20 are arranged to sense the filtered light L5 to generate an output signal OUT. The output signal OUT is processed by a processing circuit 22 to construct the depth information of the object 30 according to the output signal OUT. As shown in FIG. 3 in conjunction with FIG. 1, the depth information construction system 1 can be applied to an electronic device 1a. More specifically, the electronic device 1a can be any kind of electronic device having a processor 3 with computing power or control ability such as a mobile phone, a laptop computer, a virtual reality (VR) device, etc. It should be noted that the number of the sensors 20 shown in FIG. 1 is only for illustrative purpose, and is not limited by the present disclosure.

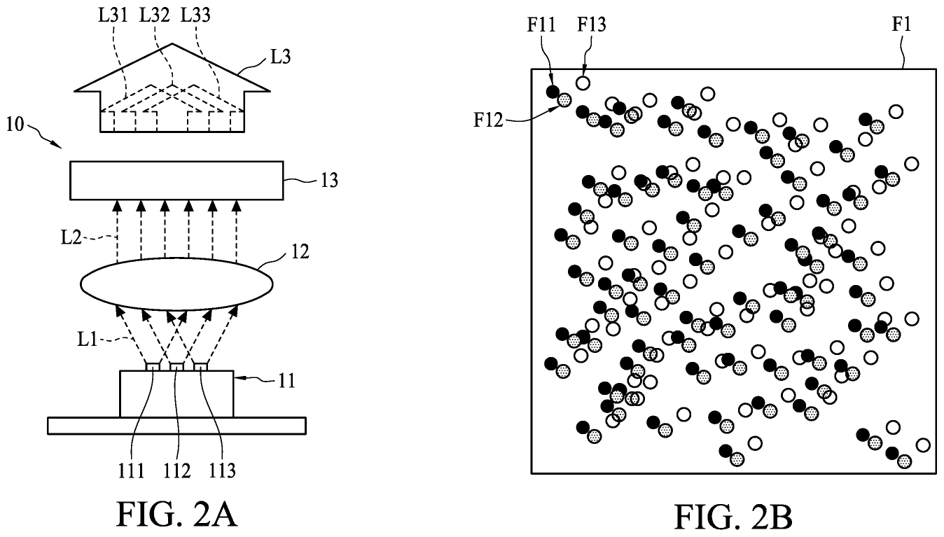

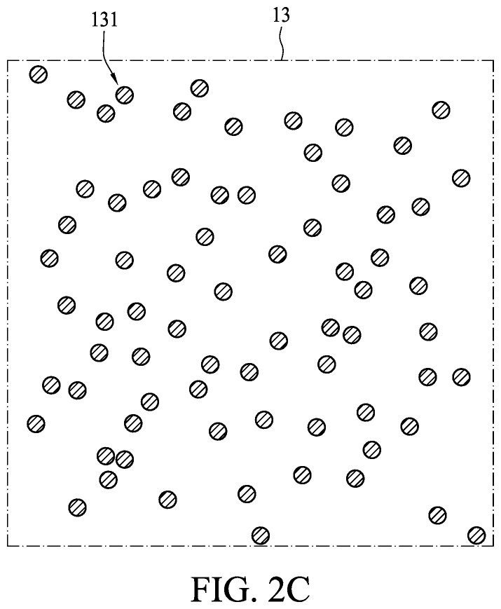

Referring to FIG. 2A, in one embodiment, the structured light generator 10 includes a light source 11, a collimating lens 12 and a diffractive optical element (DOE) 13. The light source 11 includes a plurality of light source units 111, 112 and 113. The collimating lens 12 is disposed between the plurality of light source units 111, 112, and 113 of the light source 11 and the DOE 13. In this embodiment, the plurality of light source units are uniformly arranged. For example, the plurality of light source units are arranged in an n*n array, wherein n is a positive integer. Those skilled in the art should readily understand that the number of the light source units is not limited, and different numbers of the light source units are possible within the scope of the present disclosure. The plurality of light source units 111, 112 and 113 are driven to emit monochromatic light L1 to the collimating lens 12. In this embodiment, the monochromatic light L1 is an infrared light, and the wavelength of the infrared light is about 940 nm.

When the monochromatic light L1 emitted by the plurality of light source units 111, 112 and 113 reaches the collimating lens 12, the collimating lens 12 collimates the monochromatic light L1 in parallel, forming the collimated monochromatic light L2. The collimating lens 12 can be optional in the present disclosure. The collimated monochromatic light L2 is projected toward the DOE 13. With the DOE 13, the collimated monochromatic light L2 is diffracted as the structured light L3.

In this embodiment, the DOE 13 has a pattern which is pseudorandomly arranged. For example, the pattern of the DOE 13 is a pseudorandom optical imprint 131 as shown in FIG. 2C. When the collimated monochromatic light L2 reaches the DOE 13, the structured lights L31, L32 and L33 having the pattern are projected onto the object 30. As shown in FIG. 2A, the structured lights L31, L32 and L33 have patterns F11, F12 and F13, respectively. Each of the patterns F11, F12 and F13 corresponds to the pseudorandom optical imprint 131. Therefore, the structured light generator 10 projects a structured light L3 combining the structured lights L31, L32 and L33 onto the object 30.

In other embodiments, the DOE 13 has a pattern uniformly arranged, such as an n*n array, wherein n is a positive integer. Those skilled in the art should readily understand the detail of this alternative design. The detailed description is omitted here for brevity.

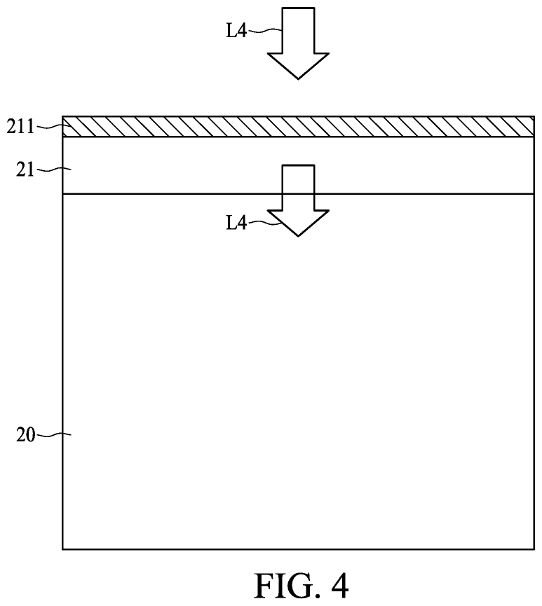

Referring back to FIG. 1, when the structured light generator 10 projects the structured light L3 onto the object 30, the structured light L3 is reflected by the object 30 as the reflected structured light L4 to the diffuser lens assemblies 21. FIG. 4 is a diagram illustrating one of the diffuser lens assemblies 21 and the corresponding sensor 20 in accordance with an embodiment of the present disclosure. As shown in FIG. 4, the diffuser lens assembly 21 has a coating 211 as an infrared light pass filter for filtering the reflected structured light L4, and for allowing only the light with 940 nm wavelength to enter the sensor 20. Therefore, most part of the natural light reflected by the object 30 is filtered. The filtered light L5 with 940 nm wavelength enters the corresponding sensor 20. It should be noted that the entry direction of the filtered light L5 is only for illustrative purpose. Those skilled in the art should understand that the filtered light L5 after passing the diffuser lens assembly 21 should be randomly diffused into the corresponding sensor 20.

In the conventional devices applying a structured light generator, the sensor must be distant from the structured light generator to obtain the depth information of the object accurately. In contrast, with the help of the diffuser lens assemblies 21, more accurate depth information is obtained when the sensors 20 are closer to the structured light generator 10. Therefore, the depth information construction system 1 provided by the present disclosure can be much smaller than the conventional structured light 3D devices, and occupied area is reduced as a result.

Conventional devices adapting a diffuser lens usually cooperate with an illuminating system adapting uniform light to construct the depth information. For example, a diffuser lens is placed in front of a sensor, and the device encodes a 3D scene into a 2D image on the sensor. A one-time calibration consists of scanning a point source on an object axially while capturing images. The point source can be formed by reflecting uniform light (e.g., the natural light). The images are reconstructed computationally by solving nonlinear inverse problem with a sparsity prior. Since the object is composed by infinite point sources, the backend processing circuit has to process infinite light information reflected by the object, and processing the infinite light information greatly increases the burden of the processing circuit.

In contrast, since the diffuser lens assemblies 21 filter most of the natural light reflected by the object 30, and the diffuser lens assemblies 21 allow only the light with 940 nm wavelength to enter, the resolution of the output signal OUT generated by the sensors 20 is defined by the pattern on the DOE 13. For example, when the DOE 13 has a pattern with a 100*100 array and the light source 11 has only one light source unit, the structured light L3 with 940 nm wavelength includes information of only 10,000 lights projected on the object 30. The output signal OUT includes information of 10,000 lights reflected by the object 30 and filtered by the diffuser lens assembly 21, which defines the resolution of the output signal OUT. Therefore, the processing circuit 22 needs to process information of only 10,000 lights to generate the depth information. As a result, the computing power of the processing circuit 22 is not required to be very high to generate the depth information. Therefore, for an electronic device applying the processing circuit 22, the battery life of the electronic device can be extended.

Compared to the distance between the sensors 20 and the structured light generator 10, the distance between the depth information construction system 1 and the object 30 is much greater. As a result, an angle between the structured light L3 and the reflected structured light LA is approximately 0 degrees.

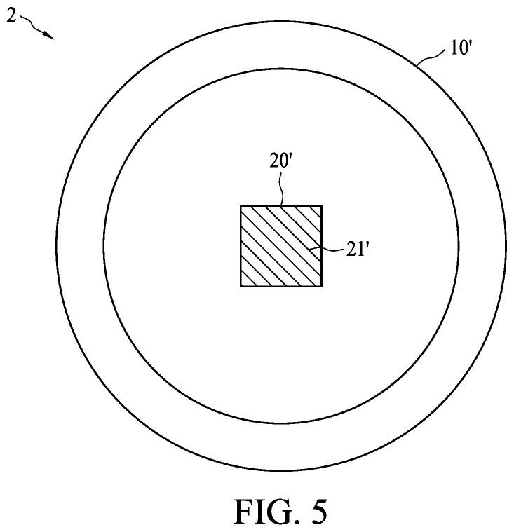

The arrangement of the structured light generator 10 and the sensors 20 are not limited to that shown in FIGS. 1 and 2A. FIG. 5 is a top view diagram illustrating a depth information construction system 2 in accordance with another embodiment of the present disclosure. As shown in FIG. 5, the depth information construction system 2 includes, a structured light generator 10′, a diffuser lens assembly 21′, and a sensor 20′ coupled to the diffuser lens assembly 10. The structured light generator 10′ may be arranged in a ring-shaped structure surrounding the sensor 20′ with diffuser 21′ as shown in FIG. 5. The structured light generator 10′ surrounds the sensor 20′ instead of being disposed aside the sensor 20′. In this way, a center of the structured light generator 10′ and a center of the sensor 20′ may substantially overlap with each other. Such an arrangement may further improve precision of the depth information.

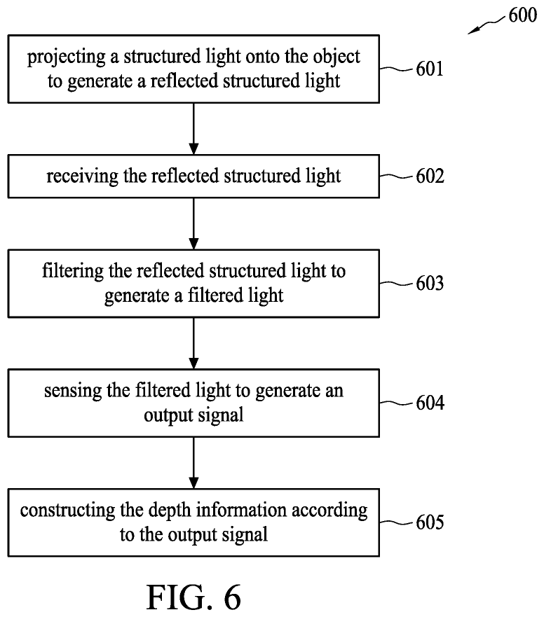

FIG. 6 is a flowchart illustrating a depth information constructing method 600 in accordance with an embodiment of the present disclosure. Provided that the results are substantially the same, the steps shown in FIG. 6 are not required to be executed in the exact order shown. The method 600 is summarized as follows.

Step 601: a structured light is projected onto an object to generate a reflected structured light.

Step 602: the reflected structured light is received.

Step 603: the reflected structured light is filtered to generate a filtered light.

Step 604: the filtered light is sensed to generate an output signal.

Step 605: the depth information is constructed according to the output signal.

Those skilled in the art should readily understand the detail of the depth information constructing method 600 after reading the abovementioned embodiments. The detailed description is omitted here for brevity.

What is claimed is:

1. A depth information construction system arranged to generate an output signal for a processing circuit to construct a depth information of an object according to the output signal, the depth information construction system comprising:
a structured light generator, arranged to project a structured light onto the object to generate a reflected structured light:
a diffuser lens assembly, disposed adjacent to the structured light generator, wherein the diffuser lens assembly is arranged to receive the reflected structured light and generate a filtered light; and
a sensor, arranged to sense the filtered light to generate the output signal.

2. The depth information construction system of claim 1, wherein an angle between the structured light and the reflected structured light is approximately 0 degrees.

3. The depth information construction system of claim 1, wherein the structured light is a monochromatic light.

4. The depth information construction system of claim 3, wherein the monochromatic light includes infrared light.

5. The depth information construction system of claim 4, wherein the wavelength of the infrared light is about 940 nm, and the wavelength of the filtered light is about 940 nm.

6. The depth information construction system of claim 4, wherein the diffuser lens assembly includes an infrared light pass filter.

7. The depth information construction system of claim 3, wherein the structured light generator comprises:
a light source, arranged to emit the monochromatic light; and
a diffractive optical element (DOE) over the light source, the DOE having a pattern thereon, wherein the pattern defines a resolution of the output signal.

8. The depth information construction system of claim 7, wherein the structured light generator further comprises:
a collimating lens between the light source and the DOE, the collimating lens being arranged to collimate the monochromatic light.

9. The depth information construction system of claim 7, wherein the pattern is uniformly arranged.

10. The depth information construction system of claim 7, wherein the pattern is pseudorandomly arranged.

11. The depth information construction system of claim 1, wherein the diffuser lens and the sensor is surrounded by the light source.

12. An electronic device for constructing a depth information of an object, comprising:
a structured light generator, arranged to project a structured light onto the object to generate a reflected structured light;
a diffuser lens assembly, disposed adjacent to the structured light generator, wherein the diffuser lens assembly is arranged to receive the reflected structured light and generate a filtered light;
a sensor, arranged to sense the filtered light to generate an output signal; and
a processor, arranged to construct the depth information according to the output signal.

13. A depth information constructing method for constructing a depth information of an object, comprising:
projecting a structured light onto the object to generate a reflected structured light;
receiving the reflected structured light;
filtering the reflected structured light to generate a filtered light;
sensing the filtered light to generate an output signal; and
constructing the depth information according to the output signal.

14. The method of claim 13, wherein an angle between the structured light and the reflected structured light is approximately 0 degrees.

15. The method of claim 13, wherein the structured light is a monochromatic light.

16. The method of claim 15, wherein the monochromatic light includes infrared light.

17. The method of claim 16, wherein the wavelength of the infrared light is about 940 nm, and the wavelength of the filtered light is about 940 nm.
